(19) United States
(12) Patent Application Publication
(10) Pub. No.: US 2011/0032838 A1
(43) Pub. Date: Feb. 10, 2011

(54) MITIGATION OF CRS MISALIGNMENT IN COORDINATED MULTIPOINT COMMUNICATIONS

(75) Inventors: Ke Liu, San Diego, CA (US); Xiaoxia Zhang, San Diego, CA (US); Durga Prasad Malladi, San Diego, CA (US); Hao Xu, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/849,602

(22) Filed: Aug. 3, 2010

Related U.S. Application Data
(60) Provisional application No. 61/231,298, filed on Aug. 4, 2009.

(51) Int. Cl. H04W 40/00; H04W 24/00

(52) U.S. Cl. 370/252; 370/328; 370/330

(57) ABSTRACT

Certain aspects of the present disclosure relate to a method for coordinated multipoint wireless communications. A technique for joint processing of misaligned reference signals in coordinated multipoint communications is provided. In one aspect, a cell may transmit an offsetting reference signal which, when processed by a receiving user equipment, at least partially cancels a first reference signal transmitted by the cell.

### CLAIM OF PRIORITY UNDER 35 U.S.C. §119

The present Application for Patent claims benefit of Provisional Application Ser. No. 61/231,298 filed Aug. 4, 2009, assigned to the assignee hereof, and expressly incorporated herein by reference.

### BACKGROUND

1. Field

Certain aspects of the present disclosure generally relate to wireless communications and, more particularly, to coordinated multipoint communications.

2. Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

A MIMO system supports a time division duplex (TDD) and frequency division duplex (FDD) systems. In a TDD system, the forward and reverse link transmissions are on the same frequency region so that the reciprocity principle allows the estimation of the forward link channel from the reverse link channel. This enables the access point to extract transmit beamforming gain on the forward link when multiple antennas are available at the access point.

### SUMMARY

Certain aspects provide a method for wireless communications. The method generally includes transmitting a first reference signal in a first group of tones, transmitting an offsetting reference signal in a second group of tones, wherein the offsetting reference signal is suitable for at least partially cancelling the first reference signal when combined with the first reference signal, and transmitting data in a third group of tones.

Certain aspects provide a method for wireless communications. The method generally includes receiving a first reference signal in a first group of tones, receiving an offsetting reference signal in a second group of tones, wherein the offsetting reference signal is suitable for at least partially cancelling the first reference signal when combined with the first reference signal, and receiving data in a third group of tones.

Certain aspects provide an apparatus for wireless communications. The apparatus generally includes a reference signal (RS) module configured to generate a first reference signal, an offset module configured to generate an offsetting reference signal in a second group of tones, wherein the offsetting reference signal is suitable for at least partially cancelling the first reference signal when combined with the first reference signal. The apparatus also includes a transmit module configured to transmit the first and second groups of tones. In some aspects, the offset module generates the offsetting reference signal based at least in part on the first reference signal Additionally, the transmit module may be configured to transmit a data signal within a same symbol period as the offsetting reference signal.

Certain aspects provide an apparatus for wireless communications. The apparatus generally includes a receiver configured to receive a first reference signal in a first group of tones, and to receive an offsetting reference signal in a second group of tones, wherein the offsetting reference signal is suitable for at least partially cancelling the first reference signal when combined with the first reference signal. The receiver may be further configured to receive data in a third group of tones.

Certain aspects provide an apparatus for wireless communications. The apparatus generally includes means for transmitting a first reference signal in a first group of tones, means for transmitting an offsetting reference signal in a second group of tones, wherein the offsetting reference signal is suitable for at least partially cancelling the first reference signal when combined with the first reference signal, and means for transmitting data in a third group of tones.

Certain aspects provide an apparatus for wireless communications. The apparatus generally includes means for receiving a first reference signal in a first group of tones, means for receiving an offsetting reference signal in a second group of tones, wherein the offsetting reference signal is suitable for at least partially cancelling the first reference signal when combined with the first reference signal, and means for receiving data in a third group of tones.

Certain aspects provide a computer-program product for wireless communications, comprising a computer readable medium having instructions stored thereon, the instructions being executable by one or more processors. The instructions generally includes code for causing a first reference signal to be transmitted in a first group of tones, code for causing an offsetting reference signal to be transmitted in a second group of tones, wherein the offsetting reference signal is suitable for at least partially cancelling the first reference signal when combined with the first reference signal; and code for causing data to be transmitted in a third group of tones.

Certain aspects provide a computer-program product for wireless communications, comprising a computer readable medium having instructions stored thereon, the instructions being executable by one or more processors. The instructions generally includes code for causing a first reference signal to be received in a first group of tones, code for causing an offsetting reference signal to be received in a second group of tones, wherein the offsetting reference signal is suitable for at least partially cancelling the first reference signal when combined with the first reference signal, and code for causing data to be received in a third group of tones.

Certain aspects provide an apparatus for wireless communications, comprising at least one processor and a memory coupled to the at least one processor. The at least one processor is generally configured to cause a first reference signal to be transmitted in a first group of tones, an offsetting reference signal to be transmitted in a second group of tones, wherein the offsetting reference signal is suitable for at least partially cancelling the first reference signal when combined with the first reference signal, and data to be transmitted in a third group of tones.

Certain aspects provide an apparatus for wireless communications, comprising at least one processor and a memory coupled to the at least one processor. The at least one processor is generally at least one processor configured to cause a first reference signal to be received in a first group of tones, an offsetting reference signal to be received in a second group of tones, wherein the offsetting reference signal is suitable for at least partially cancelling the first reference signal when combined with the first reference signal, and data to be received in a third group of tones.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 illustrates a multiple access wireless communication system according to one embodiment;

FIG. 2 illustrates a block diagram of a communication system;

FIG. 3 illustrates a block diagram of a coordinated transmission in accordance with an aspect of the disclosure;

FIG. 4 illustrates a block diagram of an example system that enables joint processing in coordinated multi-point transmissions;

FIG. 5 illustrates a block diagram of a coordinated transmission scheme in accordance with an aspect of the disclosure;

FIG. 6 illustrates a block diagram of a coordinated transmission scheme in accordance with an aspect of the disclosure;

FIG. 7 illustrates a flow chart diagram of a method for wireless communications in accordance with an aspect of the disclosure; and

FIG. 8 illustrates a flow chart diagram of a method for wireless communications in accordance with an aspect of the disclosure.

FIG. 9 illustrates a block diagram of a coordinated transmission in accordance with an aspect of the disclosure;

### DESCRIPTION

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). Cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). Cdma2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

Referring to FIG. 1, a multiple access wireless communication system according to one embodiment is illustrated. An access point 100 (AP) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal 122 is in communication with antennas 106 and 108, where antennas 106 and 108 transmit information to access terminal 122 over forward link 126 and receive information from access terminal 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access point. In the embodiment, antenna groups each are designed to communicate to access terminals in a sector of the areas covered by access point 100.

The transmitting antennas of access point 100 may utilize beamforming in order to improve the signal-to-noise ratio of forward links for the different access terminals 116 and 124. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as an access point, a Node B, an Evolved Node B (eNB), or some other terminology. An access terminal may also be called an access terminal, user equipment (UE), a wireless communication device, terminal, mobile station, or some other terminology.

In communication over forward links 120 and 126, access point 100 may transmit a common reference signal (CRS). The resources used for transmitting the CRS may be based upon a cell identity of the access point 100. Due to the cell-specific nature of CRS signals, access terminals 116, 122 may experience interference when receiving transmissions from multiple access points in a coordinated transmission. As described herein, access point 100 may be configured to reduce such interference by generating an offsetting reference signal which at least partially cancels the cell-specific CRS.

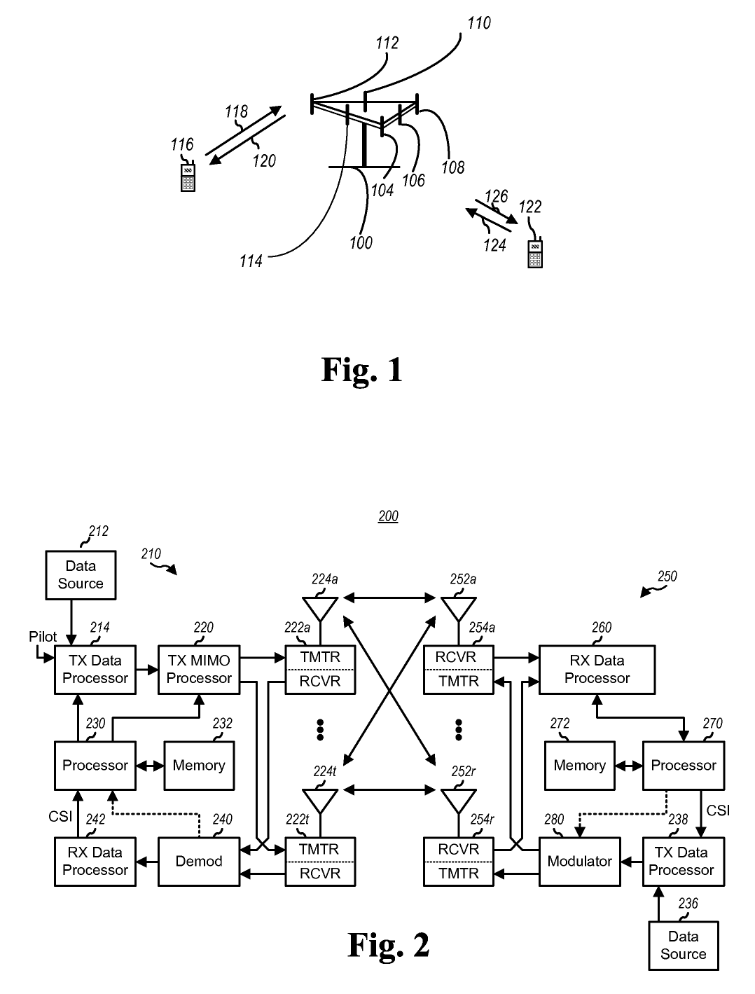

FIG. 2 is a block diagram of an embodiment of a transmitter system 210 (also known as the access point) and a receiver system 250 (also known as access terminal) in a MIMO system 200. At the transmitter system 210, traffic data for a number of data streams is provided from a data source 212 to a transmit (TX) data processor 214.

In an embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. For example, in LTE systems, an access point may transmit pilot data over a reference signal (RS). The RS may be a common reference signal (CRS) and can include a plurality of reference symbols which are transmitted at known locations in each downlink subframe. The location of the reference symbols may vary according to a cell identity of the access point (cell-specific shifting).

Multiplexed pilot and coded data for each downlink data stream is modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

In an aspect, logical channels are classified into Control Channels and Traffic Channels. Logical Control Channels comprises Broadcast Control Channel (BCCH) which is DL channel for broadcasting system control information. Paging Control Channel (PCCH) which is DL channel that transfers paging information. Multicast Control Channel (MCCH) which is Point-to-multipoint DL channel used for transmitting Multimedia Broadcast and Multicast Service (MBMS) scheduling and control information for one or several MTCHs. Generally, after establishing RRC connection this channel is only used by UEs that receive MBMS (Note: old MCCH+MSCH). Dedicated Control Channel (DCCH) is Point-to-point bi-directional channel that transmits dedicated control information and used by UEs having an RRC connection. In aspect, Logical Traffic Channels comprises a Dedicated Traffic Channel (DTCH) which is Point-to-point bi-directional channel, dedicated to one UE, for the transfer of user information. Also, a Multicast Traffic Channel (MTCH) for Point-to-multipoint DL channel for transmitting traffic data.

In an aspect, Transport Channels are classified into DL and UL. DL Transport

Channels comprises a Broadcast Channel (BCH), Downlink Shared Data Channel (DL-SDCH) and a Paging Channel (PCH), the PCH for support of UE power saving (DRX cycle is indicated by the network to the UE), broadcasted over entire cell and mapped to PHY resources which can be used for other control/traffic channels. The UL Transport Channels comprises a Random Access Channel (RACH), a Request Channel (REQCH), a Uplink Shared Data Channel (UL-SDCH) and plurality of PHY channels. The PHY channels comprise a set of DL channels and UL channels.

The DL PHY channels comprises:

Common Pilot Channel (CPICH)

Synchronization Channel (SCH)

Common Control Channel (CCCH)

Shared DL Control Channel (SDCCH)

Multicast Control Channel (MCCH)

Shared UL Assignment Channel (SUACH)

Acknowledgement Channel (ACKCH)

DL Physical Shared Data Channel (DL-PSDCH)

UL Power Control Channel (UPCCH)

Paging Indicator Channel (PICH)

Load Indicator Channel (LICH)

The UL PHY Channels comprises:

Physical Random Access Channel (PRACH)

Channel Quality Indicator Channel (CQICH)

Acknowledgement Channel (ACKCH)

Antenna Subset Indicator Channel (ASICH)

Shared Request Channel (SREQCH)

UL Physical Shared Data Channel (UL-PSDCH)

Broadband Pilot Channel (BPICH)

In an aspect, a channel structure is provided that preserves low PAR (at any given time, the channel is contiguous or uniformly spaced in frequency) properties of a single carrier waveform.

For the purposes of the present document, the following abbreviations apply:

AM Acknowledged Mode

AMD Acknowledged Mode Data

ARQ Automatic Repeat Request

BCCH Broadcast Control CHannel

BCH Broadcast CHannel

C- Control-

CCCH Common Control CHannel

CCH Control CHannel

CCTrCH Coded Composite Transport Channel

CP Cyclic Prefix

CRC Cyclic Redundancy Check

CTCH Common Traffic CHannel

DCCH Dedicated Control CHannel

DCH Dedicated CHannel

DL DownLink

DSCH Downlink Shared CHannel

DTCH Dedicated Traffic CHannel

FACH Forward link Access CHannel

FDD Frequency Division Duplex

L1 Layer 1 (physical layer)

L2 Layer 2 (data link layer)

L3 Layer 3 (network layer)

LI Length Indicator

LSB Least Significant Bit

MAC Medium Access Control

MBMS Multimedia Broadcast Multicast Service

MCCH MBMS point-to-multipoint Control CHannel

MRW Move Receiving Window

MSB Most Significant Bit

MSCH MBMS point-to-multipoint Scheduling CHannel

MTCH MBMS point-to-multipoint Traffic CHannel

PCCH Paging Control CHannel

PCH Paging CHannel

PDU Protocol Data Unit

PHY PHYsical layer

PhyCH Physical CHannels

RACH Random Access CHannel

RLC Radio Link Control

RRC Radio Resource Control

SAP Service Access Point

SDU Service Data Unit

SHCCH SHared channel Control CHannel

SN Sequence Number

SUFI SUper FIeld

TCH Traffic CHannel

TDD Time Division Duplex

TFI Transport Format Indicator

TM Transparent Mode

TMD Transparent Mode Data

TTI Transmission Time Interval

U- User-

UE User Equipment

UL UpLink

UM Unacknowledged Mode

UMD Unacknowledged Mode Data

UMTS Universal Mobile Telecommunications System

UTRA UMTS Terrestrial Radio Access

UTRAN UMTS Terrestrial Radio Access Network

MBSFN multicast broadcast single frequency network

MCE MBMS coordinating entity

MCH multicast channel

DL-SCH downlink shared channel

MSCH MBMS control channel

PDCCH physical downlink control channel

PDSCH physical downlink shared channel

Generally, a coordinated multipoint (CoMP) system may be used to reduce cell-edge interference, improve cell-edge spectrum efficiency, and enlarge effective cell-edge coverage. In one approach, joint processing in a CoMP system involves multiple eNBs sending coordinated transmissions to a UE using the same time and frequency resources. The multiple eNBs may share information between themselves, such as channel state information, cell identifiers, timing information, and other data, to coordinate transmissions with the UE.

Joint processing by eNBs in a CoMP system may involve multiple eNBs sending coordinated transmissions to a UE in the same time and frequency resources. Due to the possibility of cell-specific shifting of the reference sequence, the location of RS symbols may vary resulting in a misalignment among the eNBs. Misaligned reference signals, in turn, may create interference at the UE resulting in a negative impact on performance and spectral efficiency of the CoMP transmissions.

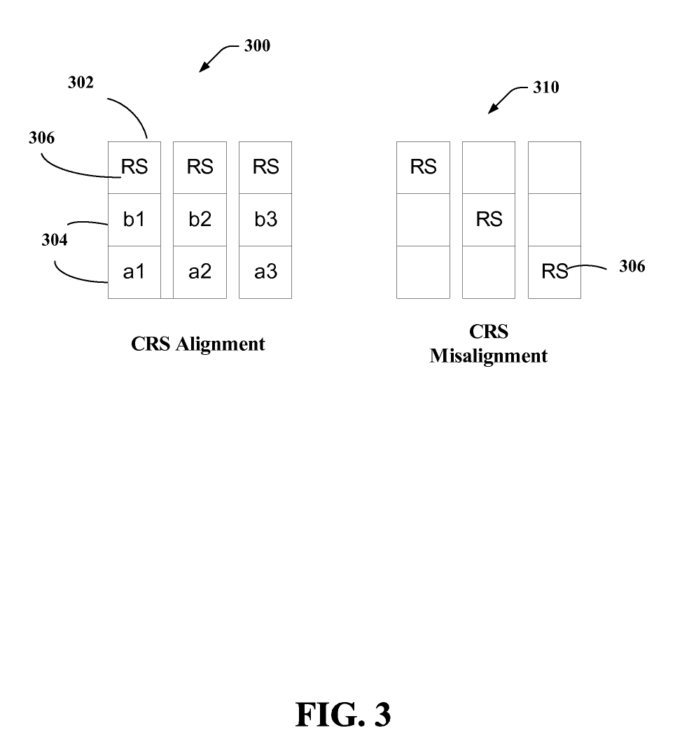

Turning to FIG. 3, coordinated transmissions 300 and 310 illustrate cases of CRS alignment and CRS misalignment, respectively. The coordinated transmission 300 may be transmitted by eNBs in a CoMP system, such as, for example, eNBs 402 described below. The coordinated transmission 300 generally includes groups 302 of symbols which are transmitted over resource elements (REs) 304. The groups 302 are shown as columns. The coordinated transmission 300 may include signals “a” and “b”, which are CoMP transmission symbols. As illustrated, signals “a” and “b” comprise transmission symbols (namely, a1, a2, a3, and b1, b2, b3) by three cells in a CoMP set.

As shown, eNBs in the coordinated transmission 300 periodically transmit a reference signal (RS) 306 across the groups of REs 302. In one aspect, the RS 306 may be a CRS. Assuming that each eNB has at least two transmit antennas, the RS 306 may be transmitted every three consecutive REs. At each cell, the relative position of the RS tone 306 in its corresponding group may be determined based on the cell identity (e.g., the cell identity modulo 3). It is noted that in the case of a one transmit antenna system, a three-RE group may still apply by including a “Null” RS tone in the group.

The case of CRS alignment is illustrated by coordinated transmission 300. As shown, the RSs 306 are transmitted in a same symbol location in each group of REs 302. Cell ID planning, for example, may be used to avoid cell-specific shifting resulting in a resource utilization of ⅔ (two thirds of the symbols allocated to transmission symbols a and b).

The case of CRS misalignment is illustrated by coordinated transmission 310. As shown, the RSs 306 do not align in the RE groups. Since UEs may not know the cell identities of each access point, the misaligned RS transmissions can create interference and thereby reduce the benefits of joint processing. CRS misalignment among eNBs may occur, for example, when cell planning is not available or in cases where cell planning is not desireable.

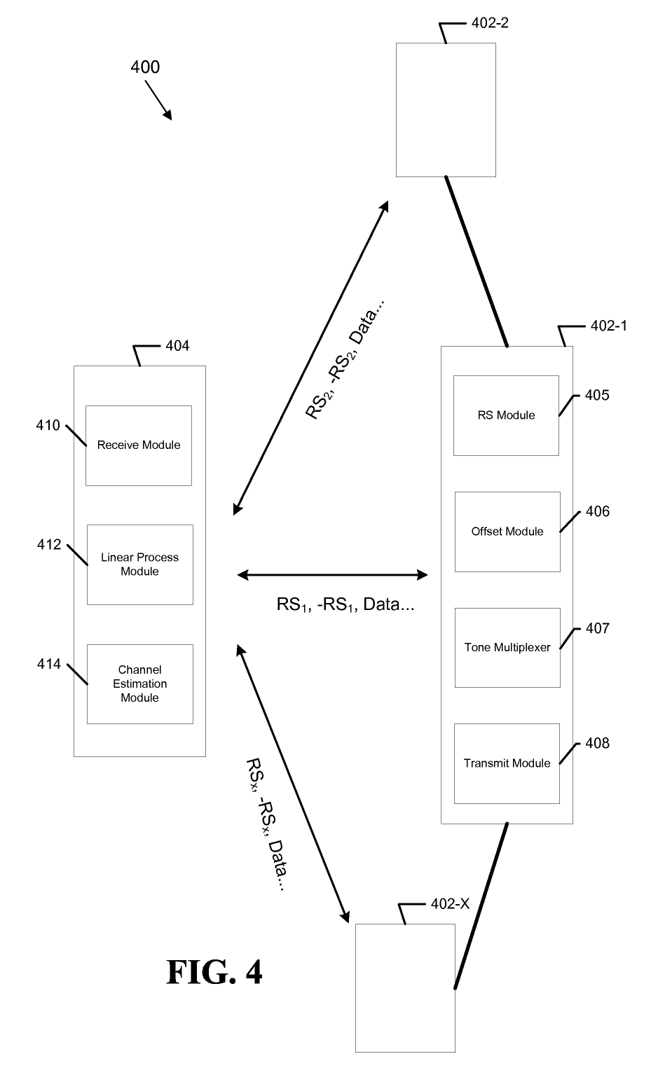

FIG. 4 illustrates an example system 400 supporting coordinated multi-point (CoMP) communications with offsetting RS transmissions. The system 400 includes access points 402 (e.g., base stations, Node Bs, eNBs, etc.) that can communicate with user equipment 404 (e.g., mobile station, mobile device, wireless terminal, and/or any number of disparate devices (not shown)). The access points 402 can transmit information to the user equipment 404 over a forward link channel or downlink channel; further access points 402 can receive information from the user equipment 404 over a reverse link channel or uplink channel.

As shown, system 400 supports CoMP transmissions to user equipment 404 are provided on the downlink. In this example, access points 402 may be referred to collectively as a “CoMP set.” Typically, one access point 402-1 in the CoMP set (e.g., a “serving” access point) may coordinate joint processing operations with the other members, 402-2 . . . 402-X (e.g., the “non-serving” or “cooperating” access points). This may include, for example, sending and receiving UE-related data, transmission parameters, etc. to the non-serving access points over a fixed backhaul. In some aspects, components and functionalities shown and described below in the base station 402 may be present in the user equipment 404 and vice versa.

As described above, joint processing by access points 402 in the CoMP set may involve multiple eNBs sending coordinated transmissions to a UE 404 in the same time and frequency resources. Due to the possibility of cell-specific shifting of the reference sequence, the location of RS symbols may vary resulting in a misalignment among the access points 402. Misaligned reference signals, in turn, may create interference at the UE 404 resulting in a negative impact on performance and spectral efficiency of the CoMP transmissions. Advantageously, access points 402 compensate for the effects of RS-misalignment thereby improving resources utilization.

Each access point 402 may include an RS module 405, an offset module 406, a tone multiplexer 407, and a transmit module 408 for mitigating the effect of misaligned RS signals among members of the coordinated multi-point set. RS module 405 may be configured to generate a reference signal for transmission on the downlink. In LTE systems, for example, the RS module 405 may generate a common reference signal (CRS) based on a cell identity of the access point 402. This may include, for example, forming a symbol-by-symbol product of an orthogonal sequence and a pseudo-random sequence to represent one of 504 unique cell identities. Multiple RS sequences and signals may be utilized with MIMO operating modes.

In one embodiment, the RS module 405 may be coupled to an offset module 406 and a tone multiplexer 407. The offset module 406 may be configured to generate an offsetting reference signal (“−RS”) based at least in part on RS symbols from the RS module 405. The offsetting RS may be a complex value and may be generated with opposite signs, polarities, etc. such that the corresponding RS symbol is at least partially cancelled when the symbols are combined at the UE 404. For example, offset module 406 can generate the offsetting reference symbols to mitigate the effect of corresponding RS symbols when a linear combination is formed at the UE 404.

The tone multiplexer 407 may receive the RS symbol and the offsetting RS symbol from the RS module 405 and may be configured to map the symbols to tones in a downlink transmission. The location of the RS tones within a subframe may be predetermined so that the RS tones can be located by the UE 404 and used for coherent demodulation, channel estimation, etc. The tone multiplexer 407 may select different tones for the offsetting RS symbol, for example, in a same symbol period as the corresponding RS symbol. The tone multiplexer 407 may vary the selection of the location of the offsetting RS tones within the symbol period as the corresponding RS symbol. In one aspect, the tone multiplexer 407 receives data symbols for downlink transmission and is configured to map the RS symbol to a first group of tones, the offsetting RS symbol to a second group of tones, and the data symbols to a third group of tones.

The transmit module 408 is coupled to the tone multiplexer 407 and may be configured to transmit a first group of tones including the RS symbol, a second group of tones including the offsetting RS symbol, and a third group of tones including data symbols. The transmit module 408 may transmit an offsetting RS symbol and a data symbol in the same group of tones. In a further aspect, the transmit module 408 may be configured to transmit a composite signal including offsetting RS and data signals. For example, an offsetting reference symbol may be superimposed on a data symbol and transmit module 408 may operate to transmit both in a same symbol location or symbol period.

The user equipment 404 may include a receive module 410 and a linear process module 412. The receive module 410 may be configured to receive transmissions from access points 402 including a first reference signal in a first group of tones, an offsetting reference signal in a second group of tones, and data in a third group of tones. For example, the receive module 410 may receive a common reference signal, an offsetting common reference signal, and data symbols from the access points 402 in the CoMP set in one or more groups.

The linear process module 412 may form a linear combination of the signals from receive module 410. For example, where the channel for a group of three resource elements (REs) is roughly flat, the UE 404 may calculate the signal mode using the equation y=h1*a1+h2*a2+h3*a3+n. In this example, by combining the RS with the offsetting RS signal, the system 400 may realize a ⅓ resource utilization for full joint processing gain. Advantageously, the offsetting RS technique of CoMP system 400 enables effective joint processing even with uncertain CRS shifting patterns.

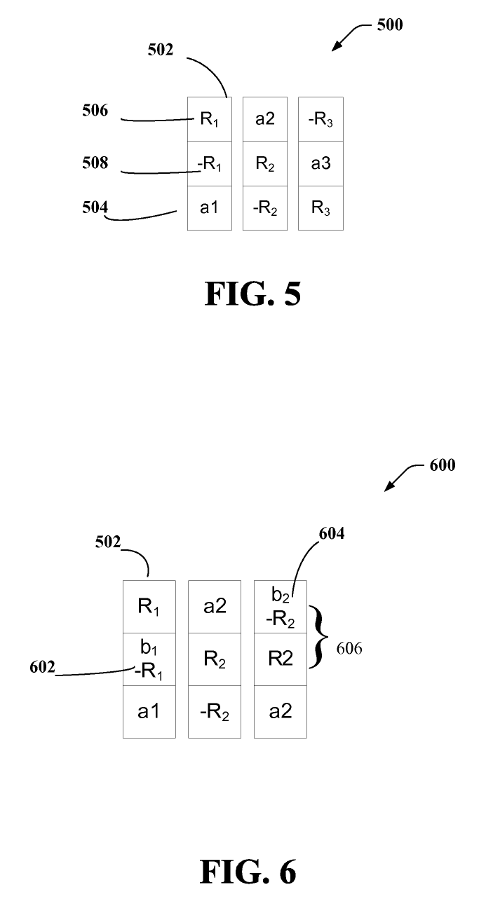

FIG. 5 illustrates an exemplary coordinated transmission 500 with offsetting reference signals according to aspects of the disclosure. The coordinated transmission 500 by eNBs 402 generally includes groups 502 of symbols transmitted over REs 504 which are shown as columns. The coordinated transmission 500 may include a signal “a”, comprising CoMP transmission symbols. As illustrated, signal “a” comprises transmissions symbols (namely, a1, a2, a3.)

RS 506 may be generated by the RS module 405 of the eNBs 402 for transmission on the downlink. Offset module 406 may generate offsetting RS 508 based at least in part on the RS symbols 506. In one aspect, the RS 506 and offsetting RS 508 may be mapped to tones in a downlink transmission by a tone multiplexer 407. In one aspect, the tone multiplexer 407 may map the RS 506 for every three REs 504 based on the cell identity of the respective eNB 402. The tone multiplexer 407 may also select and/or vary the location of offsetting RS 508 within the group of tones. The coordinated transmission 500 including RS 506, offsetting RS 508, and a data signal “a” may be transmitted over the REs 504 using a transmit module 408 of eNBs.

At the receiver, a UE 404 may receive the signals using a receive module 410 and process the received REs 504 together. In one aspect, the linear process module 412 of the UE 404 may process the received signals to retrieve the RS 506 and data signal “a”. Due to the inclusion of the offsetting RS, UE 404 may operate without knowledge of cell identities, notwithstanding CRS misalignment.

Returning to FIG. 4, in one embodiment, the UE 404 may further include a channel estimation module 414 coupled to the receive module 410 and linear process module 412. The channel estimation module 414 may be configured to retrieve RSs from received transmissions (in receive module 410) or processed transmissions (in linear process module 412.) In one aspect, the channel estimation module 414 may use RSs to derive a channel estimate for each eNBs 402 in a CoMP set.

According to one aspect, a UE 404 may be aware of a pattern of an offsetting RS and may exploit the “extra” RS to improve channel estimation quality. The UE 404 may receive an indication of the pattern of the offsetting RS, of the original RS, or of the data, through any suitable means, for example, signaling. In one aspect, the serving eNB 402-1 may signal a plurality of CoMP parameters, including an offsetting RS pattern, a number of eNBs in the CoMP, and cell identities of eNBs in the CoMP, using transmit module 408. The receive module 410 of UE 404 may receive the signaled parameters and relay the parameters to channel estimation module 414. In one aspect, the channel estimation module 414 may retrieve the offsetting RS signal from received downlink transmission based on the signaled offsetting RS pattern. The channel estimation module 414 may further use the offsetting RS signal as another factor in estimating channel quality between the UE 404 and eNBs 402.

According to another aspect, alternative RS patterns may be used to reduce the required processing and/or resulting interference. In one aspect, such as the above example, linear process module 412 may assume 3-RE processing. In another aspect, where fewer RS patterns are present within the CoMP set, the serving eNB 402-1 may signal to the UE 404 a number of RS patterns present within the CoMP set. Information relating to the RS pattern may be conveyed to the UE 404 using any suitable signaling means, for example, PDCCH or L3 signaling. In one aspect, the receive module 410 receives an indication of the number of RS patterns and relays the indication to the linear process module 412. The linear process module 412 may be configured to change processing span of received downlink transmission based on the received indication. As such, the required processing RE span can be reduced and/or the resulting interference can be reduced as well.

As illustrated in FIG. 5, it is assumed that the eNB 402 transmits an offsetting RS in a RE without transmitting any useful data in that RE. According to yet another aspect, the eNB 402 may transmit a composite signal which may be a combination of both the offsetting RS and useful data, or one signal superimposed on another, to achieve better spectral utilization.

As seen in FIG. 6, an exemplary coordinated transmission 600 by eNBs 402 is illustrated according to aspects of the disclosure. While the coordinated transmission 600 is illustrated as a two cell transmission, the technique may extend to transmission of three cells or greater. Similar to the coordinated transmissions 500 described above, the coordinated transmission 600 by eNBs 402 generally includes groups 502 of symbols transmitted over REs which are shown as columns.

The coordinated transmission 600 may include an offsetting RS symbol combined with a data symbol, creating a composite signal 602 (denoted as “b1-R1”). In one embodiment, tone multiplexer 407 of the eNB 402 may be configured to map data symbols (“b1”) to tones within the same symbol location or period as the offsetting RS symbols (“−R1”). In one specific example, the tone multiplexer 407 may be configured to select the same tones for the offsetting RS symbol and at least one of the data symbols. In this case, adding the first two REs 606 gives rise to additional symbols (b1 and b2), thus achieving ⅔ resource utilization.

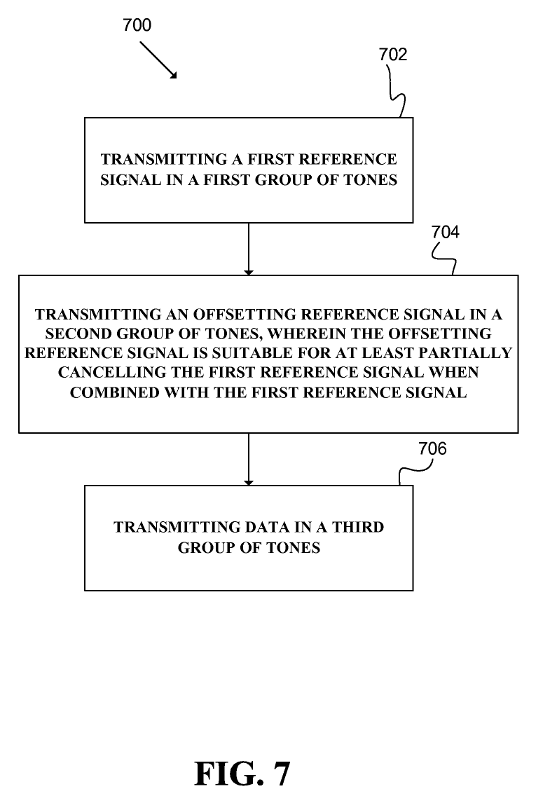

FIG. 7 illustrates exemplary operations 700 that may be performed by an eNB 402 in accordance with aspects of the disclosure. At 702, the eNB 402 may transmit a first reference signal in a first group of tones. The first reference signal may comprise a cell-specific reference signal or a common reference signal. In one aspect, the group of tones may be part of a resource block group comprising resource elements. The relative position of the first group of tones within the resource block group may be determined by a cell identity. In one aspect, the eNB 402 may transmit as part of a coordinated multi-point transmission.

At 704, the eNB 402 may transmit an offsetting reference signal in a second group of tones. The offsetting reference signal is suitable for at least partially cancelling the first reference signal when combined with the first reference signal. In one aspect, the offsetting reference signal may be combined with the first reference signal using linear processing, summation, or any other suitable processing technique. At 706, the eNB 402 may transmit data in a third group of tones.

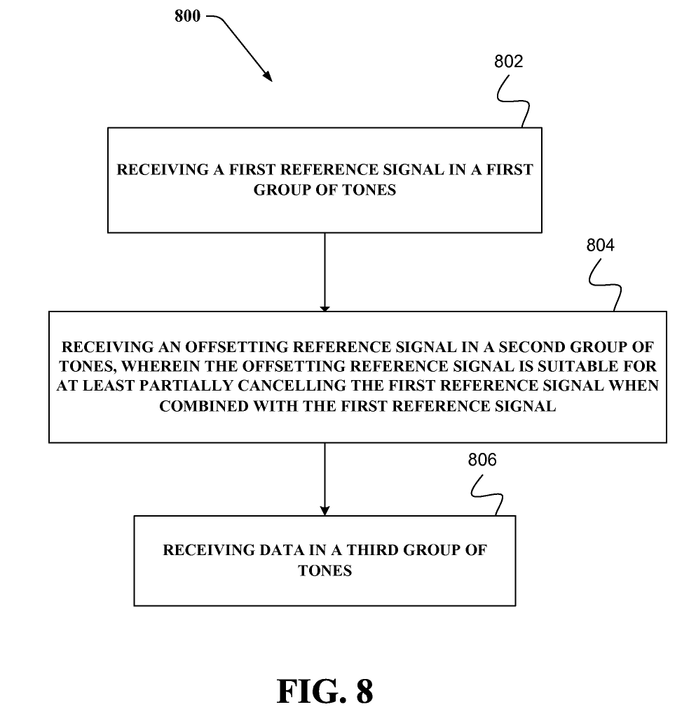

FIG. 8 illustrates exemplary operations 800 that may be performed by an UE 404 in accordance with aspects of the disclosure. At 802, the UE 404 may receive a first reference signal in a first group of tones. The first reference signal may comprise a cell-specific reference signal or a common reference signal. In one aspect, the group of tones may be part of a resource block group comprising resource elements. The relative position of the first group of tones within the resource block group may be determined by a cell identity. In another aspect, the transmitting may be part of a coordinated multi-point transmission.

At 804, the UE 404 may receive an offsetting reference signal in a second group of tones. The offsetting reference signal is suitable for at least partially cancelling the first reference signal when combined with the first reference signal. In one aspect, the UE may combine the offsetting reference signal with the first reference signal using linear processing, summation, or any other suitable processing technique. At 806, the UE may receive data in a third group of tones.

According to a further aspect of the disclosure, an eNB 402 may transmit a signal which offsets the RS impact of the other cooperating cells in the CoMP set using downlink explicit channel information. As such, at the receiver, the UE 404 may not see the impact of the CRS. The downlink explicit channel information may or may not be available in a FDD system depending on a UE feedback scheme. However, for a TDD system, the eNBs 402 may know the channel information due to the reciprocity property of the TDD wireless channel. As such, using the channel information, an eNB 402 may offset the RS impact of the other cooperating cells in the CoMP set.

In another aspect, CRS symbol skipping techniques may be employed. While processing a transmission, an eNB 402 may skip the CRS-occupied symbol for CoMP. However, CRS symbol skipping may result in significant overhead. For example, for a subframe with a control format indicator set to 1, there are at least 3 CRS symbols out of a total of 13 data symbols. As such, the CRS symbol skipping technique would incur a spectrum efficiency loss of 23%, which may offset much of the gain found in using joint processing.

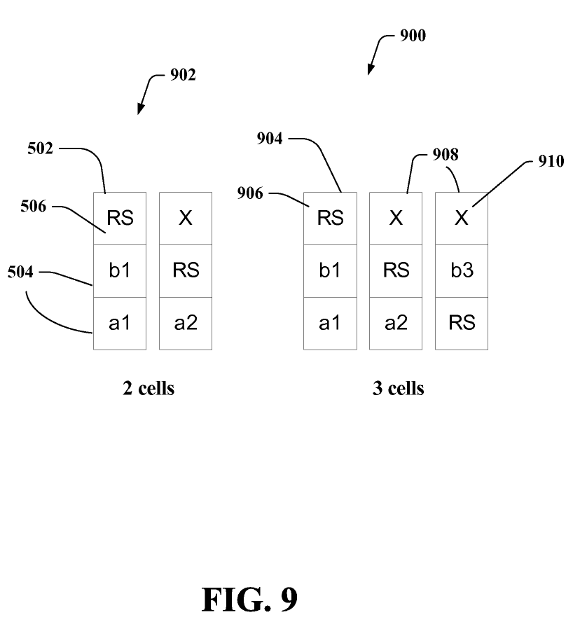

In yet another aspect, rate matching techniques may be employed. According to one aspect, cooperating cells may rate-match around the RS of the serving cell. FIG. 9 illustrates exemplary coordinated transmissions 900, 902 by eNBs 402. In one aspect, the coordinated transmission 900 by eNBs 402 may include a transmission from three cells. In an alternative aspect, coordinated transmission 902 may include a transmission from two cells. Similar to the coordinated transmission 500 described above, the coordinated transmissions 900, 902 by eNBs 402 generally include groups 502 of symbols transmitted over REs 504.

The coordinated transmissions 900, 902 may include signals “a” and “b”, which are CoMP transmission symbols. In the case of coordinated transmission 500, signals “a” and “b” comprise transmission symbols (namely, a1, a2, a3, and b1, b2, b3) by three cells. According to the case of coordinated transmission 902, signals “a” and “b” comprise transmission symbols (namely, a1, a2, and b1, b2) by two cells. The coordinated transmissions 900, 902 may further include a reference signal (RS) 506 transmitted periodically across the REs 504.

As illustrated in FIG. 9, a first eNB 402 may be designated as a serving eNB 402-1. The RS module 405 of the serving eNB 402-1 may generate a CRS 906 for downlink transmission. The transmit module 408 may transmit a group of tones including a CRS tone 906 using a first RE 904. Cooperating eNBs 402-2 and 402-X may choose to transmit an empty tone to rate-match around CRS 906 over REs 908. (The notation “X” denotes the empty RE 910.) In one aspect, the tone multiplexers 407 of the cooperating eNBs 402-2 and 402-X may selectively map an empty symbol to a tone corresponding to the location of the CRS 906.

Using this approach, joint processing may be provided for the two-cell transmission 902, e.g., the symbols “a1” and “a2”. This may provide ⅓ of maximal joint processing resource utilization, assuming UE 404 does know at which RE the joint processing would occur. Since a UE 404 operating in transparent mode may not know the RS position of the second cell, additional control information may be provided to coordinate the transmissions. For example, the serving eNB 402-1 may provide UE-specific joint processing information in PDCCH or through higher layer messages. However, in some cases, even when such information is provided to the UE 404 the full joint processing benefit may not be realized due to puncturing (as illustrated in the above 3-cell transmission 900.) Puncturing may cause a model mismatch as the channel experienced by the UE 404 on the RS tones is different from the one measured from the DRS.

A hybrid approach may also be used which draws from the various embodiments and techniques described herein. For example, a technique for mitigating the CRS shifting impact to CoMP may be used which combines cell planning, rate-matching, and the use of offsetting RS. A serving cell, for example, may selectively determine which scheme is to be used. The serving cell may utilize downlink control transmission (e.g., PDCCH) to signal the selected scheme to cooperating cells and devices. Accordingly, ⅔ or ⅓ resource utilization for the CRS occupied symbols may be achieved It will be recognized that the offsetting-RS approach described herein is scalable and, as such, may be particularly beneficial for a large CoMP set. A UE 404 may operate in transparent mode in association with dedicated RS pilot schemes. On the other hand, the rate-matching approach may be suitable for small CoMP set for higher rate.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for wireless communications, comprising:
transmitting a reference signal in a first group of tones;
transmitting an offsetting reference signal in a second group of tones, wherein the offsetting reference signal is suitable for at least partially cancelling the reference signal when combined with the reference signal; and
transmitting data in a third group of tones.

2. The method of claim 1, wherein the transmitting comprises transmitting in time and frequency resources associated with a coordinated multi-point (CoMP) transmission.

3. The method of claim 1, further comprising generating the offsetting reference signal based at least in part on the reference signal.

4. The method of claim 1, further comprising:
generating a composite signal comprising the offsetting reference signal and a data signal; and
transmitting the composite signal in the second group of tones.

5. The method of claim 4, wherein transmitting the composite signal comprises transmitting the data signal within a same symbol period as the offsetting reference signal.

6. The method of claim 1, wherein the groups of tones comprise a resource block group.

7. The method of claim 1, wherein frequency resources of the first group of tones are determined by a cell identity.

8. A method for wireless communications, comprising:
receiving a reference signal in a first group of tones; and
receiving an offsetting reference signal in a second group of tones, wherein the offsetting reference signal is suitable for at least partially cancelling the reference signal when combined with the reference signal; and
receiving data in a third group of tones.

9. The method of claim 8, wherein the groups of tones comprise a resource block group.

10. The method of claim 8, wherein the receiving comprises receiving the first, second, and third groups of tones from access points in a coordinated multi-point (CoMP) transmission.

11. The method of claim 8, wherein frequency resources of the first group of tones are determined by a cell identity.

12. The method of claim 8, wherein the offsetting reference signal is combined with the reference signal using linear processing.

13. The method of claim 8, wherein receiving the offsetting reference signal comprises receiving a composite signal including a data signal with the offsetting reference signal.

14. The method of claim 13, wherein receiving the composite signal further comprises receiving the data signal in a same symbol period as the offsetting reference signal.

15. The method of claim 8, further comprising receiving an indication of an offsetting reference signal pattern.

16. The method of claim 15, further comprising estimating channel quality based on the received offsetting reference signal and the indication of the offsetting reference signal pattern.

17. The method of claim 15, further comprising processing the reference signal and the offsetting reference signal based on the indication of the offsetting reference signal pattern.

18. An apparatus for wireless communications, comprising:
means for transmitting a reference signal in a first group of tones;
means for transmitting an offsetting reference signal in a second group of tones, wherein the offsetting reference signal is suitable for at least partially cancelling the reference signal when combined with the reference signal; and
means for transmitting data in a third group of tones.

19. The apparatus of claim 18, wherein the groups of tones comprise a resource block group.

20. The apparatus of claim 18, wherein the means for transmitting comprises means for transmitting in time and frequency resources associated with a coordinated multi-point (CoMP) transmission.

21. The apparatus of claim 18, wherein the first group of tones is determined by a cell identity.

22. The apparatus of claim 18, further comprising means for generating the offsetting reference signal based at least in part on the reference signal.

23. The apparatus of claim 18, further comprising:
means for generating a composite signal comprising the offsetting reference signal and a data signal; and
means for transmitting the composite signal in the second group of tones.

24. The apparatus of claim 23, wherein the means for transmitting the composite signal comprises means for transmitting the data signal within a same symbol period as the offsetting reference signal.

25. An apparatus for wireless communications, comprising:
means for receiving a reference signal in a first group of tones; and
means for receiving an offsetting reference signal in a second group of tones, wherein the offsetting reference signal is suitable for at least partially cancelling the reference signal when combined with the reference signal; and
means for receiving data in a third group of tones.

26. The apparatus of claim 25, wherein the groups of tones comprise a resource block group.

27. The apparatus of claim 25, wherein the means for receiving comprises means for receiving the first, second, and third groups of tones from access points in a coordinated multi-point (CoMP) transmission.

28. The apparatus of claim 25, wherein frequency resources of the first group of tones are determined by a cell identity.

29. The apparatus of claim 25, further comprising means for combining the offsetting reference signal with the reference signal using linear processing.

30. The apparatus of claim 25, wherein means for receiving the offsetting reference signal comprises means for receiving a composite signal including a data signal with the offsetting reference signal.

31. The apparatus of claim 30, wherein means for receiving the composite signal further comprises means for receiving the data signal within same symbol period as the offsetting reference signal.

32. The apparatus of claim 25, further comprising means for receiving an indication of an offsetting reference signal pattern.

33. The apparatus of claim 32, further comprising means for estimating channel quality based on the received offsetting reference signal and the indication of the offsetting reference signal pattern.

34. The apparatus of claim 32, further comprising means for processing the reference signal and the offsetting reference signal based on the indication of the offsetting reference signal pattern.

35. An apparatus for wireless communications, comprising:
an RS module configured to generate a reference signal;
an offset module configured to generate an offsetting reference signal suitable for at least partially cancelling the reference signal when combined with the reference signal; and
a transmitter configured to transmit the reference signal in a first group of tones, to transmit the offsetting reference signal in a second group of tones, and to transmit data in a third group of tones.

36. The apparatus of claim 35, wherein the groups of tones comprise a resource block group.

37. The apparatus of claim 35, wherein the transmitter is further configured to transmit the groups of tones in time and frequency resources associated with a coordinated multi-point (CoMP) transmission.

38. The apparatus of claim 35, wherein the first group of tones is determined by a cell identity of the apparatus.

39. The apparatus of claim 35, wherein the offset module is configured to generate symbols for the offsetting reference signal based at least in part on corresponding symbols of the reference signal.

40. The apparatus of claim 35, wherein the offset module is configured to generate a composite signal comprising the offsetting reference signal and a data signal, and wherein the transmitter is further configured to transmit the composite signal in the second group of tones.

41. The apparatus of claim 40, wherein the transmitter is further configured to transmit the composite signal such that the data signal is transmitted within a same symbol period as the offsetting reference signal.

42. An apparatus for wireless communications, comprising:
a receiver configured to receive a reference signal in a first group of tones; and to receive an offsetting reference signal in a second group of tones, wherein the offsetting reference signal is suitable for at least partially cancelling the reference signal when combined with the reference signal; and
wherein the receiver is further configured to receive data in a third group of tones.

43. The apparatus of claim 42, wherein the groups of tones comprise a resource block group.

44. The apparatus of claim 42, wherein the receiver is further configured to receive the first, second, and third groups of tones from a access points in a coordinated multi-point (CoMP) transmission.

45. The apparatus of claim 42, wherein frequency resources of the first group of tones are determined by a cell identity.

46. The apparatus of claim 42, wherein the receiver is configured to combine the offsetting reference signal with the reference signal using linear processing.

47. The apparatus of claim 42, wherein the receiver is configured to receive a composite signal including a data signal with the offsetting reference signal.

48. The apparatus of claim 47, wherein the receiver is further configured to receive the composite signal including the data signal and the offsetting reference signal in a same symbol period.

49. The apparatus of claim 42, wherein the receiver is configured to receive an indication of an offsetting reference signal pattern.

50. The apparatus of claim 49, further comprising a channel estimation module configured to estimate channel quality based on the received offsetting reference signal and the indication of the offsetting reference signal pattern.

51. The apparatus of claim 49, further comprising a linear processing module configured to process the reference signal and the offsetting reference signal based on the indication of the offsetting reference signal pattern.

52. An apparatus for wireless communications, comprising:
at least one processor configured to cause the apparatus to:
transmit a reference signal in a first group of tones,
transmit an offsetting reference signal in a second group of tones,
wherein the offsetting reference signal is suitable for at least partially cancelling the reference signal when combined with the reference signal, and
transmit data in a third group of tones; and
a memory coupled to the at least one processor.

53. The apparatus of claim 52, wherein the groups of tones comprise a resource block group.

54. The apparatus of claim 52, wherein the at least one processor is configured to cause the apparatus to transmit in time and frequency resources associated with a coordinated multi-point (CoMP) transmission.

55. The apparatus of claim 52, wherein the first group of tones is determined by a cell identity of the wireless communication apparatus.

56. The apparatus of claim 52, wherein the at least one processor is further configured to generate the offsetting reference signal based at least in part on the reference signal.

57. The apparatus of claim 52, wherein the at least one processor is configured to generate a composite signal comprising the offsetting reference signal and a data signal, and wherein the composite signal is transmitted in the second group of tones.

58. The apparatus of claim 57, wherein at least one processor is configured to cause the apparatus to transmit the composite signal such that the data signal is transmitted in a same symbol period as the offsetting reference signal.

59. An apparatus for wireless communications, comprising:
at least one processor configured to cause the apparatus to:
receive a reference signal in a first group of tones,
receive an offsetting reference signal in a second group of tones, wherein the offsetting reference signal is suitable for at least partially cancelling the reference signal when combined with the reference signal, and
receive data in a third group of tones; and
a memory coupled to the at least one processor.

60. The apparatus of claim 59, wherein the groups of tones comprise a resource block group.

61. The apparatus of claim 59, wherein the at least one processor is configured to cause the apparatus to receive the first, second, and third groups of tones in time and frequency resources associated with a coordinated multi-point (CoMP) transmission.

62. The apparatus of claim 59, wherein frequency resources of the first group of tones are determined by a cell identity.

63. The apparatus of claim 59, wherein the at least one processor is configured to combine the offsetting reference signal with the reference signal using linear processing.

64. The apparatus of claim 59, wherein the apparatus is configured to receive a composite signal including a data signal with the offsetting reference signal.

65. The apparatus of claim 64, wherein the at least one processor configured to obtain information relating to the data signal and the offsetting reference signal within a same symbol period of the composite signal.

66. The apparatus of claim 59, wherein the at least one processor is further configured to obtain an indication of an offsetting reference signal pattern.

67. The apparatus of claim 66, wherein the at least one processor is further configured to estimate channel quality based on the received offsetting reference signal and the indication of the offsetting reference signal pattern.

68. The apparatus of claim 66, wherein the at least one processor is further configured to process the reference signal and the offsetting reference signal based on the indication of the offsetting reference signal pattern.

69. A computer-program product for wireless communications, the computer-program product comprising a computer-readable medium having instructions stored thereon, the instructions being executable by one or more processors and the instructions comprising code for:
transmitting a reference signal in a first group of tones;
transmitting an offsetting reference signal in a second group of tones, wherein the offsetting reference signal is suitable for at least partially cancelling the reference signal when combined with the reference signal; and
transmitting data in a third group of tones.

70. The computer-program product of claim 69, wherein the groups of tones comprise a resource block group.

71. The computer-program product of claim 69, wherein the code for transmitting further comprises code for transmitting in time and frequency resources associated with a coordinated multi-point (CoMP) transmission.

72. The computer-program product of claim 69, wherein the first group of tones is determined by a cell identity.

73. The computer-program product of claim 69, wherein the code further comprises code for generating the offsetting reference signal based at least in part on the reference signal.

74. The computer-program product of claim 69, wherein the code further comprises:
code for generating a composite signal comprising the offsetting reference signal and a data signal; and
code for transmitting the composite signal in the second group of tones.

75. The computer-program product of claim 74, wherein the code for transmitting the composite signal further comprises code for transmitting the data signal within a same symbol period as the offsetting reference signal.

76. A computer-program product for wireless communications, the computer-program product comprising a computer-readable medium having instructions stored thereon, the instructions being executable by one or more processors and the instructions comprising code for:
receiving a reference signal in a first group of tones; and
receiving an offsetting reference signal in a second group of tones, wherein the offsetting reference signal is suitable for at least partially cancelling the reference signal when combined with the reference signal; and
receiving data in a third group of tones.

77. The computer-program product of claim 76, wherein the groups of tones comprise a resource block group.

78. The computer-program product of claim 76, wherein the code for receiving further comprises code for receiving the first, second, and third groups of tones from access points in a coordinated multi-point (CoMP) transmission.

79. The computer-program product of claim 76, wherein the first group of tones is determined by a cell identity.

80. The computer-program product of claim 76, further comprising code for combining the offsetting reference signal with the reference signal.

81. The computer-program product of claim 76, wherein code for receiving the offsetting reference signal further comprises code for receiving a composite signal including a data signal with the offsetting reference signal.

82. The computer-program product of claim 81, wherein the code for receiving the composite signal further comprises code for receiving the data signal within a same symbol period as the offsetting reference signal.

83. The computer-program product of claim 76, wherein the code further comprises code for receiving an indication of an offsetting reference signal pattern.

84. The computer-program product of claim 83, wherein the code further comprises code for estimating channel quality based on the received offsetting reference signal and the indication of the offsetting reference signal pattern.

85. The computer-program product of claim 83, wherein the code further comprises code for processing the reference signal and the offsetting reference signal based on the indication of the offsetting reference signal pattern.
